(19) United States
(12) Patent Application Publication
(10) Pub. No.: US 2010/0224832 A1
(43) Pub. Date: Sep. 9, 2010

(54) Modified nano-dot, fabrication method thereof and composition element thereof

(75) Inventors: Jwo-Huei Jou, Hsin-Chu (TW); Wei-Ben Wang, Hsin-Chu (TW); Mao-Feng Hsu, Hsin-Chu (TW); Cheng-Chung Chen, Hsin-Chu (TW)

Correspondence Address: HUDAK, SHUNK & FARINE, CO., L.P.A., 2020 FRONT STREET, SUITE 307, CUYAHOGA FALLS, OH, 44221, US

(73) Assignee: NATIONAL TSING HUA UNIVERSITY, HSIN-CHU (TW)

(21) Appl. No.: 12/660,556

(22) Filed: Mar. 1, 2010

(30) Foreign Application Priority Data
Mar. 4, 2009 (TW) 098107023

(51) Int. Cl. C09K 11/06

(52) U.S. Cl. 252/301.33; 977/774

(57) ABSTRACT

The present invention discloses a modified nano-dot and a fabrication method thereof. The modified nano-dot comprises a surface portion having a functional group and a core portion comprising a polymeric metal oxide, polymeric metalloid oxide or polymeric metal alloy oxide. The mean particle size of the modified nano-dot is 1-100 nm, preferably 1-10 nm. The modified nano-dot capable of modulating a carrier flux can be further applied to the element manufacture in the organic semiconductor industry, optoelectronics industry, and solar cell industry.

### BACKGROUND OF THE INVENTION

(a) Field of the Invention

The present invention relates a modified nano-dot, a fabrication method thereof and a composition element thereof, and more particularly to a modified nano-dot for modulating a carrier flux.

(b) Description of the Prior Art

Currently, it has been known that polymeric nano-dots (PNDs) can effectively improve the device efficiency of organic light emitting diodes and are suitable for use in high quality displays and large area illumination. In contrast to dry-processed electrically neutral quantum-dots and nano-dots, polymeric nano-dots can be synthesized with precisely controlled size and wet-processed on soft substrates, enabling the realization of large area-size, roll-to-roll fabrication of flexible displays and lighting. To replace the current display technologies and especially the present illumination measures, such as incandescent bulbs and fluorescent tubes, the existing nano-dots must be modified to improve their carrier modulation capability to achieve high device efficiency.

Previous studies at depositing quantum-dots into an emissive layer or incorporating nano-dots in a non-emissive layer of an organic light emitting diode have shown significant efficiency improvement, but only for low-efficiency devices. However, no report has yet revealed these approaches to be effective as well on high-efficiency devices, seriously limiting their practical applicability. The low electroluminescence (EL) efficiency may be attributed to a number of causes, comprising high carrier-injection-barrier, low carrier- and exciton-confinement, excitons forming on a guest, poor energy-transfer efficiency, intrinsically low material electroluminescence, and, most critically, imbalanced carrier-injection, etc. J. H. Jou of Tsing Hua University proposed that the polymeric nano-dots incorporated into a non-emissive layer could significantly enhance the efficiency of a white-light organic light emitting diode and could provide relatively improved efficiency in TW Pat. No. 200850042 (2008). However, the overall efficiency is still low even though the relative improvement is strikingly sound (still less than 25 lm/W).

### SUMMARY OF THE INVENTION

In consideration of the above problems of the prior art, it is an objective of the present invention to provide a modified nano-dot capable of significantly enhancing the efficiency of organic electronic elements, such as organic light emitting diodes, organic solar cells and the like. The modified nano-dot comprises two main portions: a surface portion which may comprise a functional group, such as an amino group, a hydroxyl group, an alkyl group, an alkenyl group, a halogen group or a phosphite group; and a core portion which may comprise a polymeric metal, metalloid or metal alloy oxide. The polymeric metal oxide may comprise an oxide of aluminum, tin, magnesium, calcium, titanium, manganese, zinc, gold, silver, copper, nickel or iron. The metalloid of the polymeric metalloid oxide may comprise silicon. The mean particle size of the modified nano-dot is 1-100 nm, preferably 1-10 nm. Furthermore, the modified nano-dot possesses a high surface charge comprising a positive charge of +1 to +200 mV or a negative charge of −1 to −200 mV.

According to the objective of the present invention, a fabrication method of a modified nano-dot comprising the following steps is provided. A modifier possessing an amino group, a hydroxyl group, an alkyl group, an alkenyl group, a halogen group or a phosphite group may be provided. A polymeric metal oxide, polymeric metalloid oxide or polymeric metal alloy oxide prepared by a gel-sol process is reacted with the modifier and in turn stands still at 0-35° C. for 1-24 hours to obtain a modified nano-dot solution. The resultant solution can be directly applied to the element manufacture. The weight percent concentration of the modifier is 0.1-99.9 wt %. The weight percent concentration of the polymeric metal oxide, polymeric metalloid oxide or polymeric metal alloy oxide in the solution may be 0.1-20.0 wt %. Furthermore, the metal of the polymeric metal oxide nano-dot may comprise aluminum, tin, magnesium, calcium, titanium, manganese, zinc, gold, silver, copper, nickel or iron. The metalloid of the polymeric metalloid oxide nano-dot may comprise silicon. The mean particle size of the obtained modified nano-dot is 1-100 nm, preferably 1-10 nm. The surface charge of the modified nano-dot may be +1 to +200 mV or −1 to −200 mV.

According to the objective of the present invention, a composition element with a modified nano-dot is provided. The nano-dot is capable of effectively modulating a carrier flux and can be applied to, for example, the organic semiconductor industry, optoelectronics industry, and solar cell industry.

As described above, the modified nano-dot and the fabrication method thereof may have one or more following advantages:

(1) In order to obtain high efficiency, organic light emitting diode (OLED) devices must frequently be kept relatively thin, which would consequently limit the use of large nano-dots. The mean particle size of the modified nano-dots prepared according to the present invention can be less than 10 nm so that they can be favorably used in OLEDs.

(2) The modified nano-dots according to the present invention are prepared in a solution state so that they can be directly applied to the elements by wet-process. This enables the modified nano-dots to be homogeneously distributed in an element.

(3) The modified nano-dots according to the present invention can possess high surface charges so that they can be favorably used in the organic semiconductor industry, optoelectronics industry, and solar cell industry. For example, in the application of organic light emitting diodes, the high surface positive or negative charges of the modified nano-dots can effectively modulate the transporting flux of the carriers via blocking or trapping mechanism. This can effectively prevent the holes from entering the emissive layer and causing imbalanced carrier-injection. Furthermore, in the presence of high repelling or dragging field arising from the highly charged nano-dots, only holes with high energy are able to succeed in passing over the barriers wherein, which in turn causes them to penetrate thereafter deeper into the emissive layer, leading carrier recombination to take place in a wider region, resulting in a brighter emission and hence a higher power-efficiency.

### BRIEF DESCRIPTION OF THE DRAWINGS

FIG. 1 shows a schematic illustration of the molecular structure of each type of modified nano-dots according to the present invention. Also shown are the profiles of their particle size;

FIG. 2 is a flow chart of a fabrication method of the modified nano-dot in FIG. 1(A);

FIG. 3 is a flow chart of a fabrication method of the modified nano-dot in FIG. 1(B);

FIG. 4 is a flow chart of a fabrication method of the modified nano-dot in FIG. 1(C); and

FIG. 5 is a chart showing the incorporation effects of different modified nano-dots at 0.7 wt % on the current density of a hole-transporting-only device consisting a hole-injection-layer of poly(3,4-ethylenedioxythiophene):poly(styrene sulfonic acid) sandwiched by a high-work-function electrode-pair.

### DETAILED DESCRIPTION OF THE PREFERRED EMBODIMENTS

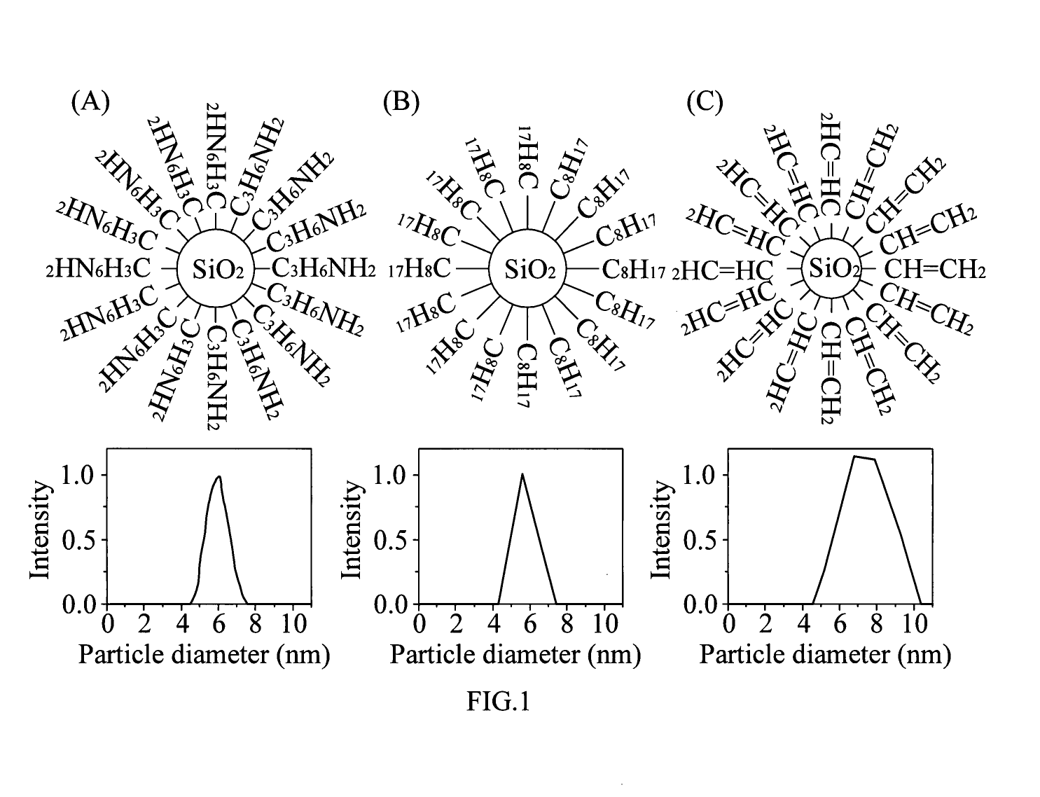

Referring to FIG. 1, there is shown a schematic illustration of the molecular structure of each type of modified nano-dots according to the present invention. Also shown are the profiles of their particle size. In this figure, FIG. 1(A) illustrates a polymeric silicon-oxide nano-dot with 3-aminopropyltriethoxysilane on the surface. Its particle size is in the range of 4-8 nm. FIG. 1(B) illustrates a polymeric silicon-oxide nano-dot with n-octyltrimethoxysilane on the surface. Its particle size is in the range of 4-8 nm. FIG. 1(C) illustrates a polymeric silicon-oxide nano-dot with vinyltrimethoxysilane on the surface. Its particle size is in the range of 5-11 nm.

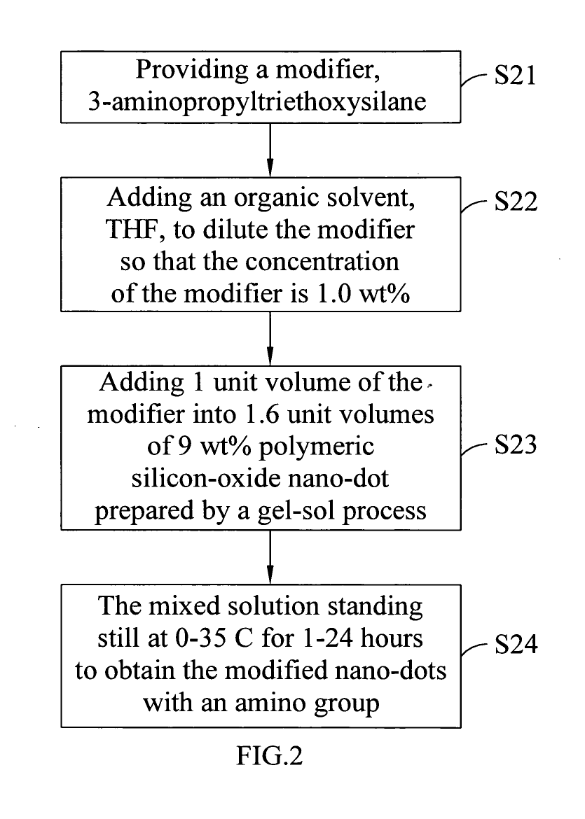

Referring to FIG. 2, there is shown a flow chart of a fabrication method of the modified nano-dot in FIG. 1(A). The steps are as follows: step S21, providing a modifier, 3-aminopropyltriethoxysilane; step S22, adding an organic solvent, tetrahydrofuran (THF), to dilute the modifier so that the weight percent concentration of the modifier is 1.0 wt %; step S23, adding 1 unit volume of the modifier into 1.6 unit volumes of 9 wt % polymeric silicon-oxide nano-dot prepared by a gel-sol process; and step S24, the mixed solution standing still at 0-35° C. for 1-24 hours to obtain the modified nano-dots with an amino group.

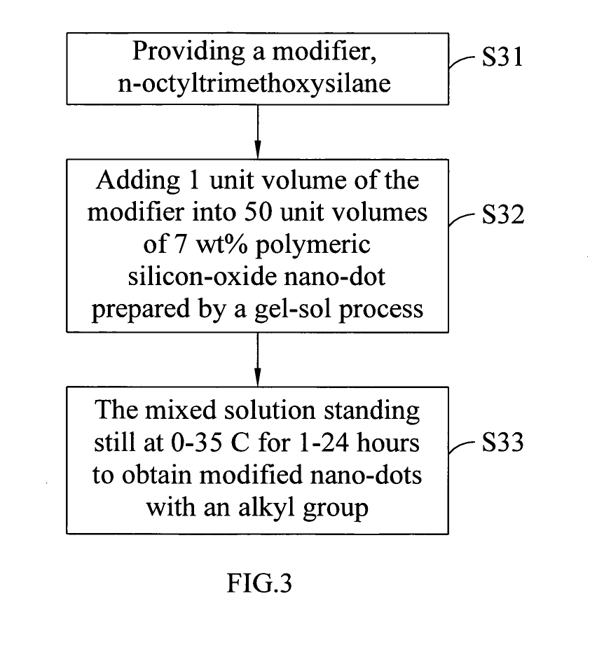

Referring to FIG. 3, there is shown a flow chart of a fabrication method of the modified nano-dot in FIG. 1(B). The steps are as follows: step S31, providing a modifier, n-octyltrimethoxysilane; step S32, adding 1 unit volume of the modifier into 50 unit volumes of 7 wt % polymeric silicon-oxide nano-dot prepared by a gel-sol process; and step S33, the mixed solution standing still at 0-35° C. for 1-24 hours to obtain modified nano-dots with an alkyl group.

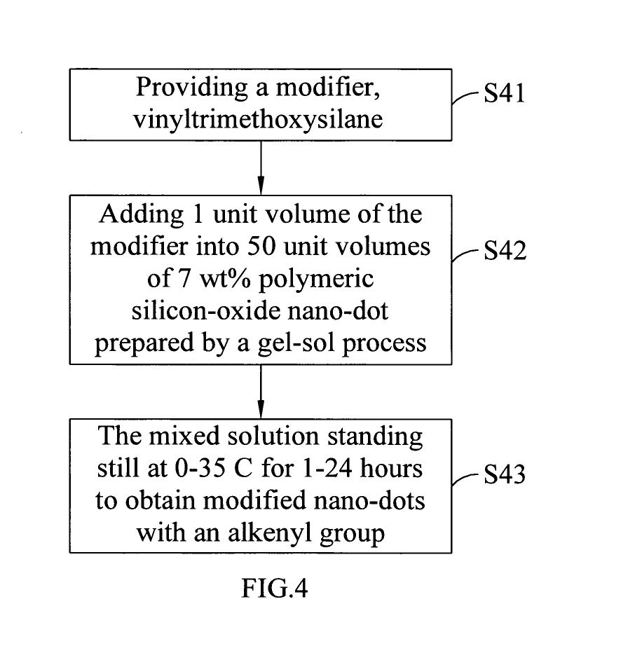

Referring to FIG. 4, there is shown a flow chart of a fabrication method of the modified nano-dot in FIG. 1(C). The steps are as follows: step S41, providing a modifier, vinyltrimethoxysilane; step S42, adding 1 unit volume of the modifier into 50 unit volumes of 7 wt % polymeric silicon-oxide nano-dot prepared by a gel-sol process; and step S43, the mixed solution standing still at 0-35° C. for 1-24 hours to obtain modified nano-dots with an alkenyl group.

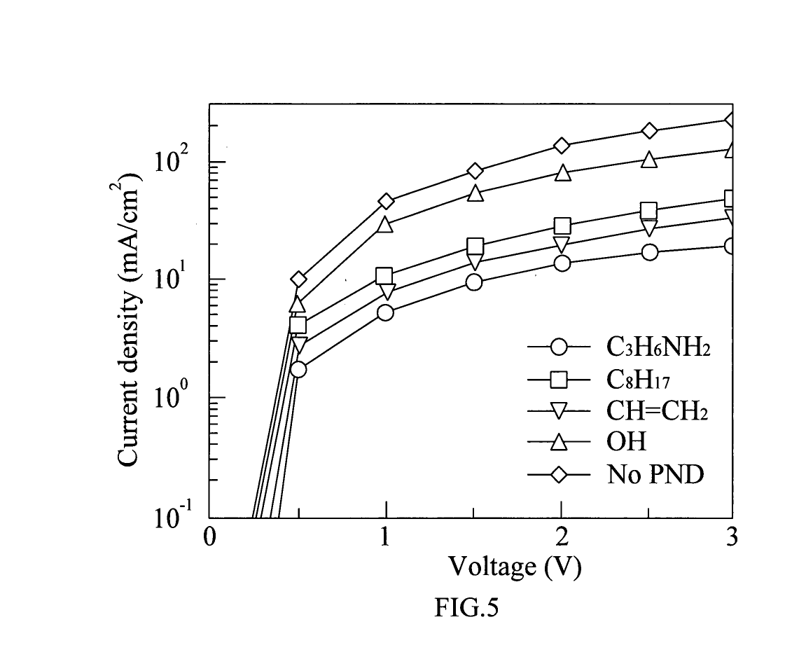

Referring to FIG. 5, there is a chart showing the incorporation effects of different modified nano-dots at 0.7 wt % on the current density of a hole-transporting-only device consisting a hole-injection-layer of poly(3,4-ethylenedioxythiophene):poly(styrene sulfonic acid) (PEDOT:PSS) sandwiched by a high-work-function electrode-pair. As amino-modified polymeric nano-dot (Am-PND) is incorporated, the current density observed is the lowest, indicating the flux of holes to be reduced to a greatest extent in the device and Am-PND to be the most effective nano-dot in hole-modulation. This may be attributed to its highest positive charge, which can presumably most effectively repel the injection of hole due to the strongest repulsive effect, and consequently result in a smallest hole-transporting-flux, maximizing the recombination probability of hole with the minor carrier, electron. This explains why the efficiency improvement is unanimously the most marked amongst all the OLED devices studied herein, as seen in Table 1, by incorporating the Am-PND.

Negatively charged alkenyl-modified polymeric nano-dot (V-PND) also shows markedly high hole-modulation-function. Contrary to the repulsion in Am-PND, the highly negatively charged V-PND is able to trap a significant amount of holes, preventing excessive holes from entering the emissive layer, leading to a similar efficiency improvement effect. This explains why V-PND is also very effective on efficiency improvement; e.g. its incorporation improves the same blue device by 67%, as shown in Table 1.

The efficiency improvement strongly depends upon the charge intensity of the nano-dot. For examples, alkyl-modified polymeric nano-dot (Al-PND) exhibits a charge intensity of +10 mV, a value much lower than that of Am-PND (+22 mV), and its incorporation results in only 62% improvement for the same blue device. Whilst, the polymeric silicon-oxide nano-dot (H-PND) exhibits a charge intensity of −5 mV and its efficiency improvement is only 13%, as shown in Table 1.

As well as charge intensity, incorporation concentration of the nano-dots also strongly affects the efficiency. As seen in Table 1, by taking the Am-PND for example, the resultant efficiency first increases from 18.0 to 32.3 lm W⁻¹ at 100 cd m⁻² as its concentration increases from 0 to 0.35 wt %, peaks with 35.8 lm W⁻¹ at 0.7 wt %, and then decreases to 31.3 lm W⁻¹ at 7 wt %.

TABLE 1
Performance of blue phosphorescent elements affected
by each type of the modified nano-dots

| | | | | CIE 1931 |
|---|---|---|---|---|
| | | Power | | chromaticity |
| | Weight percent | efficiency | Efficiency | coordinates |
| Functional | concentration | (lm/W) at 100 | increment | (x, y) at 100 |
| group | (wt %) | cd/m² | (%) | cd/m² |
| — | — | 18.0 | — | (0.19, 0.34) |
| NH₂ | 0.35 | 32.3 | 79 | (0.18, 0.35) |
| | 0.70 | 35.8 | 99 | (0.18, 0.35) |
| | 1.00 | 31.1 | 73 | (0.18, 0.35) |
| | 7.00 | 22.2 | 23 | (0.18, 0.35) |
| C₈H₁₇ | 0.35 | 25.6 | 42 | (0.18, 0.35) |
| | 0.70 | 29.1 | 62 | (0.18, 0.35) |
| | 1.00 | 24.0 | 33 | (0.18, 0.35) |
| | 7.00 | 18.8 | 4 | (0.18, 0.35) |
| C═C | 0.35 | 25.3 | 41 | (0.18, 0.34) |
| | 0.70 | 30.0 | 67 | (0.18, 0.34) |
| | 1.00 | 24.4 | 36 | (0.18, 0.35) |
| | 7.00 | 19.6 | 9 | (0.18, 0.35) |
| OH | 0.70 | 20.3 | 13 | (0.18, 0.35) |
| | 1.00 | 21.4 | 19 | (0.18, 0.34) |
| | 7.00 | 24.4 | 36 | (0.18, 0.34) |
| | 10.00 | 22.7 | 26 | (0.19, 0.35) |

The above description is illustrative only and is not to be considered limiting. Various modifications or changes can be made without departing from the spirit and scope of the invention. All such equivalent modifications and changes shall be included within the scope of the appended claims.

1. A modified nano-dot comprising a surface portion having a functional group and a core portion comprising a polymeric metal oxide, polymeric metalloid oxide or polymeric metal alloy oxide.

2. The modified nano-dot as claimed in claim 1, wherein the functional group comprises a functional group having an amino group, a hydroxyl group, an alkyl group, an alkenyl group, a halogen group or a phosphite group.

3. The modified nano-dot as claimed in claim 1, wherein the metal of the polymeric metal oxide nano-dot is any one selected from the group consisting of aluminum, tin, magnesium, calcium, titanium, manganese, zinc, gold, silver, copper, nickel and iron.

4. The modified nano-dot as claimed in claim 1, wherein the metalloid of the polymeric metalloid oxide nano-dot is silicon.

5. The modified nano-dot as claimed in claim 1, wherein the mean particle size of the modified nano-dot is further 1 nm to 100 nm.

6. The modified nano-dot as claimed in claim 1, wherein a positive surface charge of the modified nano-dot is from +1 to +200 mV.

7. The modified nano-dot as claimed in claim 1, wherein a negative surface charge of the modified nano-dot is from −1 to −200 mV.

8. A fabrication method of a modified nano-dot comprising the following steps:
providing a modifier;
diluting the modifier with a solvent; and
mixing the diluted modifier with a nano-dot solution of a polymeric metal oxide, polymeric metalloid oxide or polymeric metal alloy oxide.

9. The fabrication method of the modified nano-dot as claimed in claim 8, wherein the weight percent concentration of the modifier diluted with the solvent is 0.1-99.9 wt %.

10. The fabrication method of the modified nano-dot as claimed in claim 8, wherein the weight percent concentration of the nano-dot solution of the polymeric metal oxide, polymeric metalloid oxide or polymeric metal alloy oxide is 0.1-20 wt %.

11. The fabrication method of the modified nano-dot as claimed in claim 8, wherein the modifier has an amino group, a hydroxyl group, an alkyl group, an alkenyl group, a halogen group or a phosphite group.

12. The fabrication method of the modified nano-dot as claimed in claim 11, wherein the modifier having the amino group is 3-aminopropyltriethoxysilane.

13. The fabrication method of the modified nano-dot as claimed in claim 11, wherein the modifier having the alkyl group is n-octyltrimethoxysilane.

14. The fabrication method of the modified nano-dot as claimed in claim 11, wherein the modifier having the alkenyl group is vinyltrimethoxysilane.

15. The fabrication method of the modified nano-dot as claimed in claim 8, wherein the solvent is tetrahydrofuran (THF), toluene or alcohol.

16. The fabrication method of the modified nano-dot as claimed in claim 8, wherein the metal of the polymeric metal oxide nano-dot is any one selected from the group consisting of aluminum, tin, magnesium, calcium, titanium, manganese, zinc, gold, silver, copper, nickel and iron.

17. The fabrication method of the modified nano-dot as claimed in claim 8, wherein the metalloid of the polymeric metalloid oxide nano-dot is silicon.

18. The fabrication method of the modified nano-dot as claimed in claim 8, wherein the mean particle size of the modified nano-dot is 1 nm to 100 nm.

19. The fabrication method of the modified nano-dot as claimed in claim 8, wherein a positive surface charge of the modified nano-dot is from +1 to +200 mV.

20. The fabrication method of the modified nano-dot as claimed in claim 8, wherein a negative surface charge of the modified nano-dot is from −1 to −200 mV.

21. A modified nano-dot composition element for modulating a carrier flux, comprising the modified nano-dot as claimed in claim 1 for modulating a carrier flux.
